(19) United States
(12) Patent Application Publication
(10) Pub. No.: US 2017/0044942 A1
(43) Pub. Date: Feb. 16, 2017

(54) Systems and Methods for Determining a Remaining Life of Fluid Onboard a Machine

(71) Applicant: Caterpillar Inc., Peoria, IL (US)

(72) Inventor: William Barnickel, Metamora, IL (US)

(73) Assignee: Caterpillar Inc., Peoria, IL (US)

(21) Appl. No.: 14/824,609

(22) Filed: Aug. 12, 2015

(51) Int. Cl. F01M 11/10; F16H 57/04

(52) U.S. Cl. CPC F01M 11/10; F16H 57/04

(57) ABSTRACT

Systems and methods for determining the remaining life of a fluid onboard a machine are disclosed. One method includes determining a dielectric constant of a fluid, determining an estimate of a remaining useful life of the fluid based at least on the determined dielectric constant of the fluid, and transmitting an indicator representing the estimate of the remaining useful life of the fluid.

### TECHNICAL FIELD

This disclosure relates generally to engine fluids and, more particularly, to systems and methods for determining a remaining life of engine oil, hydraulic fluid, or transmission fluid onboard a machine.

### BACKGROUND

Changing engine fluids such as engine oil is one of the key processes used in extending engine life. Generally, the oil in an engine is changed in accordance with a set schedule. The schedule is based on an estimate of the life of the oil under a worst case scenario. Thus, the schedule may require changing the oil prematurely. The present disclosure is aimed at solving one or more of the problems identified above.

U.S. Pat. No. 8,234,915 (the '915 patent) describes a method for determining remaining oil life prior to an oil change in an internal combustion engine that has a sump and uses a body of oil. The method of the '915 patent includes determining a number of engine revolutions permitted on a body of oil based on a determined volume and degradation of the body of oil. In particular, the method of the '915 patent describes a factor “e−kV” that accounts for an effectively reducing, i.e., dropping, volume (V) due to the oxidation and degradation of body of oil that results from the oil being exposed to elevated temperature inside engine. In the superscript “−kV”, factor “−k” represents an empirically derived constant that corresponds to reaction of the body of oil to oxidation and/or decomposition effects in the sump. However, there is a need for improved systems and methods for determining remaining life of fluids associated with a machine.

### SUMMARY

Systems and methods for determining the remaining life of a fluid onboard a machine are disclosed. One method includes receiving, from a dielectric sensor onboard a machine, a dielectric constant of a fluid onboard the machine, determining an estimate of a remaining useful life of the fluid based at least on the determined dielectric constant of the fluid, and transmitting an indicator representing the estimate of the remaining useful life of the fluid.

In another aspect, the disclosure describes system including a sensor configured to determine a dielectric constant of a fluid and a controller configured to receive or access the determined dielectric constant of the fluid and to determine an estimate of a remaining useful life of the fluid based at least on the determined dielectric constant of the fluid.

In yet another aspect, the disclosure describes a method including receiving, from a dielectric sensor onboard a machine, a dielectric constant of a fluid, determining a condition curve for the fluid based at least one the dielectric constant, determining an estimate of a remaining useful life of the fluid based at least on the condition curve, and transmitting an indicator representing the estimate of the remaining useful life of the fluid.

### BRIEF DESCRIPTION OF THE DRAWINGS

FIG. 1 is a block diagram of an engine and apparatus for determining the remaining life of fluid in an engine, according to aspects of the present disclosure.

FIG. 2 is a block diagram and data flow illustrating operation of a method for determining the remaining life of fluid in an engine, according to aspects of the present disclosure.

FIG. 3 is a graph of oxidation of a fluid in an engine vs. time, according to aspects of the present disclosure.

FIG. 4 is a graph of oxidation of a fluid in an engine vs. time, according to aspects of the present disclosure.

### DETAILED DESCRIPTION

Now referring to the drawings, wherein like reference numbers refer to like elements, there is illustrated a system 100 including an engine 102, such as an internal combustion engine, configured to combust a fuel to release the chemical energy therein and convert that energy to mechanical power. The engine 102 may be configured as part of a machine 101 such as an “over-the-road” vehicle. Such machines 101 may include a truck used in transportation or may be any other type of machine that performs some type of operation associated with an industry such as mining, construction, farming, transportation, or any other industry known in the art. For example, the machine 101 may be an off-highway truck, earth-moving machine, such as a wheel loader, excavator, dump truck, backhoe, motor grader, material handler or the like. The term “machine” can also refer to stationary equipment like a generator that is driven by an internal combustion engine to generate electricity. Additionally, a machine may also refer to an engine implemented in a marine environment such as an engine in a ship or the like.

The engine 102 can be a compression ignition engine that combusts diesel fuel, though in other aspects it can be a spark ignition engine that combusts gasoline or other fuels such as ethanol, bio-fuels, or the like. Other engine types may be used.

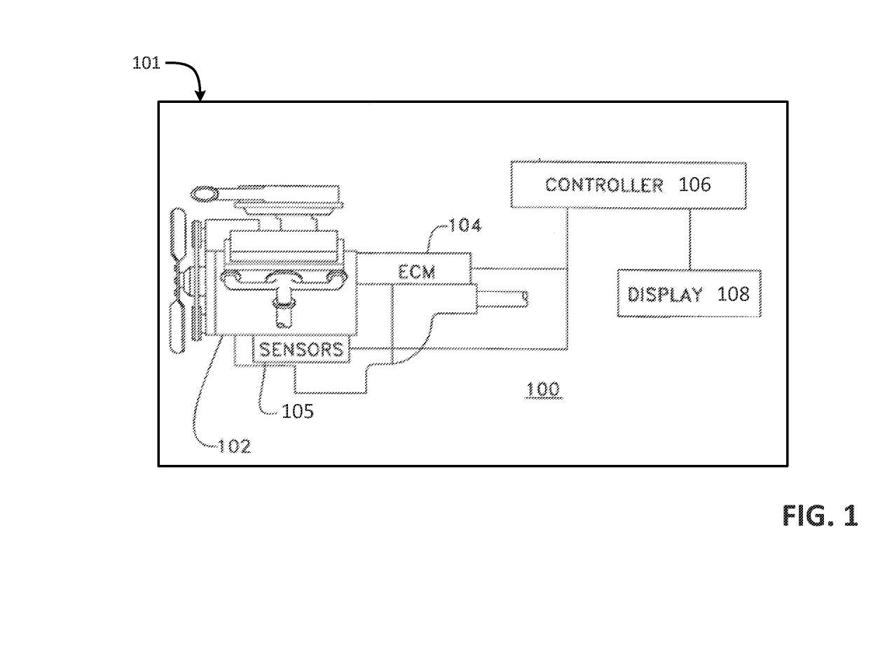

With reference to FIG. 1, a system 100 may be configured to determine a remaining life of a fluid (e.g., engine oil, transmission fluid, hydraulic fluid, etc.) onboard the machine 101, for example, in the engine 102. As shown, system 100 may include an electronic control module (ECM) 104, one or more sensors 105, a controller 106, and a display. The ECM 104 of the engine 102 may be configured to electronically control one or more operational parameters of the engine 102. In certain aspects, a set of ECMs 104 may be configured within the machine 101. The ECM 104 may be operably connected to one or more components of the machine 101 to control a working of the component. For example, the ECM 104 may include an engine control module, a transmission control module, a powertrain control module, a central control module, a brake control module, a general electronic module, a central timing module, a body control module, an implement control module, a suspension control module, and the like. As a further example, the ECM 104 may include a telematic ECM to facilitate remote testing or control of the ECM 104. Although the ECM 104 is shown in conjunction with the engine 102, in an aspect, the ECM 104 may include an extension of operable connections to other components of the machine 101, as well. Accordingly, the ECM 104 may be configured to accomplish other functions in the machine 101. Therefore, the disclosed layout of the ECM 104 and engine 102 need not be seen as being limiting in any way.

The ECM 104 may be configured to receive or access various engine data parameters such as engine speed (rpm), fuel rate (gal/hr), engine load (%), coolant temperature (° C.), total operating hours (hr), and the like. The ECM 104 may be configured to receive or access various transmission data parameters such as transmission output speed (rpm), torque converter output speed (rpm), transmission gear, engine load (%), transmission fluid temperature (° C.), torque converter oil temperature (° C.), total operating hours (hr), and the like. The ECM 104 may be configured to receive or access other data parameters relating to other components such as hydraulic and gear oils, refrigerants, and solvents.

The ECM 104 may utilize one or more of the sensors 105 for determining one or more operating parameters relating to the engine 102 or other components of the machine 101. Such sensors 105 may be configured to measure fluid properties such as dielectric constant, viscosity, density, and temperature. The sensors 105 may be configured to measure, or otherwise determine, engine hours, coolant temperature, engine speed, engine load, fuel rate, key switch, ambient air properties, and/or atmospheric properties. Other sensors may be included and may be in communication with other components such as the ECM 104.

The sensors 105 may be or include a tuning fork type sensor and may be configured to monitor a direct and/or dynamic relationship between multiple physical properties to determine the quality, condition and contaminant loading of fluids such as engine oil, fuel, transmission and brake fluid, hydraulic and gear oils, refrigerants and solvents. The sensors 105 may be configured to provide state information such as sensor failure conditions and may filter out certain data points measured via the sensors 105.

In certain aspects, the sensors 105 may include a fluid property sensor and may be configured to provide measurement information relating to one or more of a dielectric constant, a fluid temperature (° C.), a dynamic viscosity (cP), and/or density (gm/cc) of a measured fluid. The dielectric constant may be correlated with a level of oxidation of the measured fluid and may assist in detecting coolant or water entry. The fluid temperature may be used to generate a temperature profile of the fluid, which may be relied upon in subsequent analysis. The density may be used to calculate kinematic viscosity (cSt) and may relied upon for detecting fuel dilution and/or coolant/water entry.

The controller 106 may include a microprocessor and may be configured to execute operations to effect measurement of machine parameters, control of machine components (e.g., engine 102), and/or feedback to an operator or external party. As an example, the controller 106 may be configured to execute, in-part or in whole, one or more methods as described herein. As another example, the data received or accessed via the sensors 105 and/or the ECM 104 may be processed by the controller 106 to determine state information such as a remaining useful life of a fluid. As an example, at least one of the sensors 105 may be configured to measure a dielectric constant of a fluid. The measured dielectric constant may be correlated to a measure of oxidation of the fluid (e.g., in Un-subtracted FTIR (Fourier transform infrared spectroscopy) Method (UFM)), for example correlating an average measured dielectric constant to oxidation level via a linear formula (e.g., trend fitting). Other correlations and formulations may be used.

As a further example, the controller 106 may be configured to provide an output via an interface such as the display 108. The display 108 may include a visual indicator such as a liquid crystal display, a light illuminated display, and the like to indicate that a fluid should be changed and/or to illustrate the remaining life of the fluid. A signal representing that a particular fluid requires changing or representing the remaining life of the fluid may additionally or alternatively be delivered to a maintenance scheduler or dispatch office so that maintenance can be scheduled. In one aspect, the remaining life of a fluid is expressed in terms of a percentage of useful life remaining. In other aspects, the remaining life of a fluid is expressed in terms of a time of useful life remaining. Other indicators and information may be presented to an operator or external party to the machine 101.

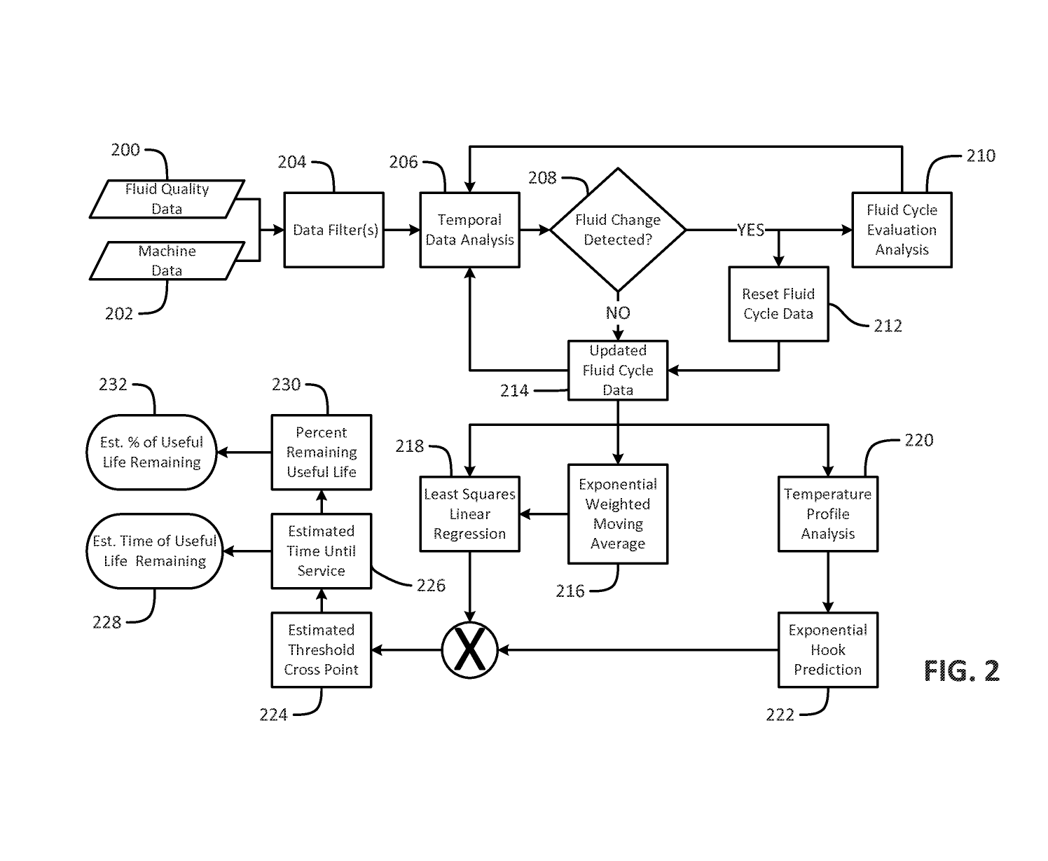

With reference to FIGS. 1 and 2, fluid data 200 may be received or accessed, for example, via one or more sensors 105. The fluid data 200 may include a dielectric constant, a fluid temperature (° C.), a dynamic viscosity (cP), and/or density (gm/cc) of a measured fluid. The dielectric constant may be correlated with a level of oxidation of the measured fluid and may assist in detecting coolant or water entry. The fluid temperature may be used to generate a temperature profile of the fluid, which may be relied upon in subsequent analysis. The density may be used to calculate kinematic viscosity (cSt) and may relied upon for detecting fuel dilution and/or coolant/water entry.

Machine data 202 may be received or accessed, for example, via the ECM 104 and/or one or more of the sensors 105. The machine data 202 may include engine speed (rpm), fuel rate (gal/hr), engine load (%), coolant temperature (° C.), total operating hours (hr), and the like. The ECM 104 may be configured to receive or access various transmission data parameters such as transmission output speed (rpm), torque converter output speed (rpm), transmission gear, engine load (%), transmission oil temperature (° C.), torque converter oil temperature (° C.), total operating hours (hr), and the like. The fluid data 200 and/or the machine data 202 may include other information such as ambient conditions (e.g., atmospheric pressure and temperature)

One or more data filters 204 may be applied to the fluid data 200 and/or the machine data 202. As an example, the fluid data 200 may be filtered by sensor status channel or state, such as sensor diagnostics. The fluid data 200 may be filtered by fluid temperature, for example, to validate one or more temperature conditions such as fluid operating temperature ranges. The machine data 202 may be filtered by engine speed, for example, to validate engine operation conditions. The machine data 202 may be filtered based on other parameters such as engine start conditions (e.g., time delay on startup). It is understood that other data filters 204 may be applied to the fluid data 200 and/or the machine data 202.

A temporal data analysis 206 may be applied to the fluid data 200 and/or the machine data 202. As an example, the fluid data 200 may be analyzed periodically (e.g., hourly, predefined time period, etc.) or continuously to determine an average dielectric constant (e.g., which correlates with oxidation), fluid temperature profile (e.g., percent and total time at temperature or temperature range), and/or an average kinematic viscosity (e.g., at specified temperatures or ranges).

As an example, the machine data 202 may be analyzed periodically (e.g., hourly) or continuously to determine average engine speed (e.g., approximate engine rotations), average fuel rate (e.g., approximate fuel burned), start count, idle time, engine load profile (e.g., percent and total time at load factors), and the like.

Fluid change detection logic may be configured to detect whether a particular fluid has been changed, at 208. As an example, the fluid change detection logic may analyze one or more of the fluid data 200 and the machine data 202 to detect changes in values such as dielectric constant values in the fluid data. Thresholds of change may be predetermined and may be empirically defined based on data collected in the field.

If a fluid change is detected, a fluid life cycle (from new fluid to change detection) may be defined and analyzed at 210. For example, fluid cycle time, temperature profile (e.g., histogram), engine rotations during cycle, fuel burned during cycle, number of starts in cycle, idle time in cycle, and other parameters may be logged and analyzed for each cycle. As such, analytics such a statistical analysis and/or machine learning may be used to determine patterns, trends, baselines, and the like for each fluid cycle and/or across groups of fluid cycles. At 212, the fluid cycle data may be reset in order to establish a new fluid period evaluation. As an example, a fluid burn off detection may be implemented based on exponentially weighted moving averages, at 216. As a further example, a new fluid period may be defined as beginning immediately after a fluid change has occurred and may end at a point determined via exponentially weighted moving averages, at 216. An endpoint of the new fluid period may be defined by a threshold change in the dielectric constant based upon a preset value and/or empirically defined data. As a further example, a least squares linear regression 218 may be defined at the end of the new fluid period, as discussed in more detail below.

If a fluid change is not detected at 208, the operation continues and additional data relating to the fluid cycle may be collected. For example, fluid cycle data may be periodically or continuously updated, at 214, until the cycle is reset. For example, fluid temperature, engine rotations, fuel burn rate, fuel burn amount, number of starts, idle time, and other parameters may be logged.

A least squares linear regression 218 may be initialized at the endpoint of the new fluid period. Data from one or more full fluid cycles may be used to provide a baseline of statistical stability. The least squares linear regression 218 may be used to define a trend line for predictive analysis, such a remaining useful life of a fluid. As an example, the least squares linear regression 218 may leverage one or more of the following formula to establish a trend line that fits with the linear formula y=m*x+b, where y=dielectric constant of the fluid and x=fluid cycle time (hr):

$$\begin{matrix}ybar = \frac{\sum ( y i )}{n} & ( 1 ) \\ xbar = \frac{\sum ( x i )}{n} & ( 2 ) \\ m = \frac{n \cdot \sum ( x i \cdot y i ) - \sum ( x i ) \cdot \sum ( y i )}{n \cdot \sum ( x {i}^{2} ) - {( \sum ( x i ) )}^{2}} & ( 3 ) \\ b = ybar - m \cdot xbar & ( 4 )\end{matrix}$$

A temperature profile analysis 220 may be implemented based on data relating to one or more fluid cycles. As an example, a period (e.g., hourly) evaluation of the percent time and total time the fluid temperature measured in particular temperature ranges may be generated. As another example, each temperature range may be associated with a degradation rate factor (DRF). Other mechanisms for generating one or more DRFs may be used including associating a DRF with various metrics such as an engine load profile, idle time counter, fuel burn counter, engine speed profile, starts counter, transmission input speed profile, transmission output speed profile, shifts counter, and/or ambient conditions profile (atmospheric pressure and temperature). In certain aspects, the DRF may be based on an estimated oxidation rate doubling for every 10° C. increment above 70° C. Other DRFs may be used. As the temporal data analysis 206 generates additional data points, the temperature profile for a fluid may be updated. Estimation on the predicted fluid break down point may be made based on the generated temperature profile (including DRFs) for the fluid and a baseline fluid life assumption, which may be generated empirically or based on a predetermined value.

An exponential hook prediction 222 may be implemented based on data relating to one or more fluid cycles. As an example, linear regression analysis may be used to establish a trend line fitting y=m*+b, with b=linear offset (e.g., new fluid starting point) and m=linear slope (e.g., general degradation rate). However, oxidation may shift to an exponential rise, termed here as an exponential hook. As such, the exponential hook prediction 222 may include logic to estimate the occurrence of exponential oxidation of the fluid. As an example, the exponential hook prediction 222 may be modeled on the following:

y=k·e^{a(x-c)} (5), where
c=Exponential Hook Offset (Data Analysis)
a=Exponential Hook Severity*
k=Exponential Hook Rate*

The model of the exponential hook prediction 222 may be combined with the linear regression analysis to generate a predicted fluid condition curve, as represented by the following formula:

y=m·x+b+k·e^{a(x-c)} (6), where
y=dielectric constant
x=fluid cycle time (hr)

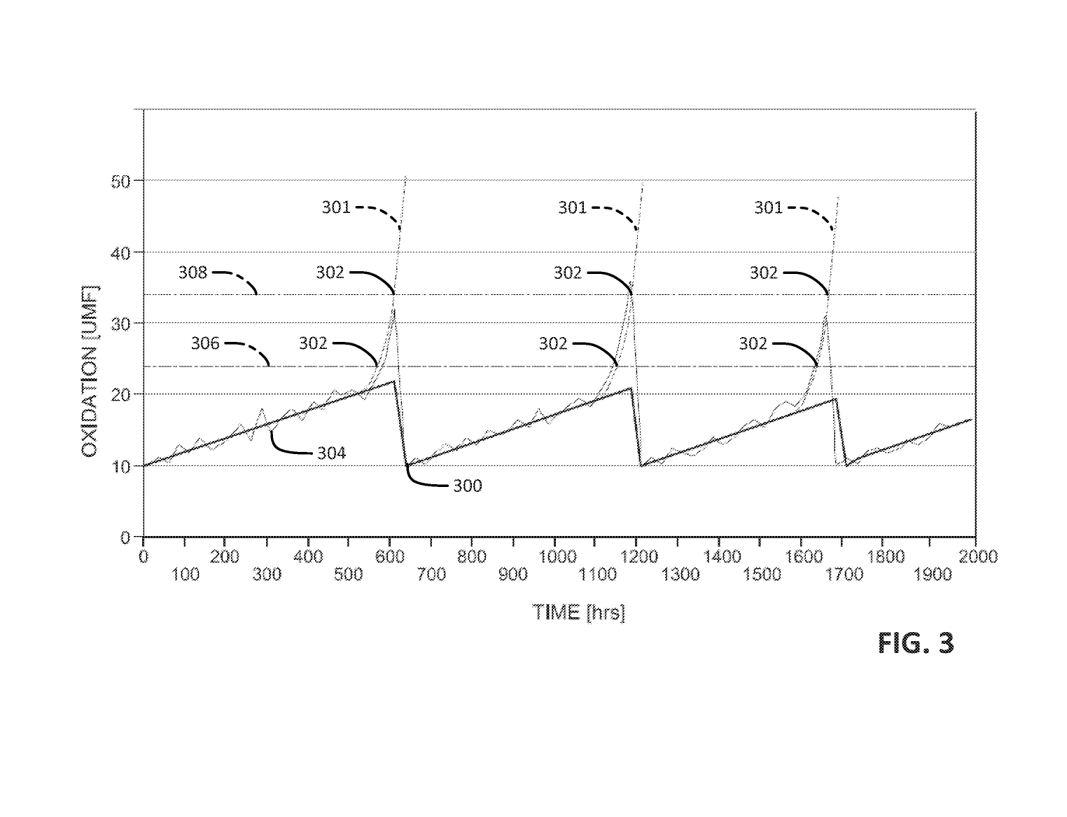

Once the fluid condition curve has been generated, a condemnation threshold cross point may be estimated, at 224. As an example, the dielectric constant threshold may be assumed as about 2.5 for engine oil. Fluids thresholds may be empirically defined or may be based on predetermined values (e.g., computer generated). As such, the condemnation threshold cross point may be determined based on the fluid condition curve crossing the established threshold for the particular fluid, as illustrated by the fluid condition curves 300, 301 and the cross points 302 in FIG. 3, shown overlaying a plot 304 of raw data. As shown, the fluid condition curves 300, 301 include a linear component (e.g., fluid condition curve 300) and an exponential component (e.g., fluid condition curve 301), as described herein. It is understood that the fluid condition curve may include one or both of the linear and exponential component to represent the oxidation estimation of the fluid. As an example, a warning threshold 306 and/or a critical threshold 308 may be predefined based on the subject fluid and the condemnation level for such a fluid. The thresholds 306, 308 may be based upon any metric including oxidation level and/or dielectric constant of the fluid.

Returning to FIG. 2, at 226, an estimated time until service may be generated based on the determined condemnation threshold cross point and the current engine operation and/or position in the fluid cycle. For example, the time until service may be the difference of the time/position of cross point and the time/position of fluid cycle. Such a determination of the estimated time until service may be transmitted, at 228, as an indicator to an operator of the machine 101 and/or a party external to the machine 101.

At 230, a percent of remaining useful life may be generated based on the determined condemnation threshold cross point and the current engine operation and/or position in the fluid cycle. For example, the percent of remaining useful life may be based on a ratio of the time/position until service and the cross point time/position. Such a determination of the percent of remaining useful life may be transmitted, at 232, as an indicator to an operator of the machine 101 and/or a party external to the machine 101. The determination of estimated time until service and/or percent of remaining useful life may be compared to other estimates generated using different methods as a validation tool.

### INDUSTRIAL APPLICABILITY

The present disclosure is applicable to machines such as a truck used in transportation or may be any other type of machine that performs some type of operation associated with an industry such as mining, construction, farming, transportation, or any other industry known in the art. For example, the machine 101 (FIG. 1) may be an off-highway truck, earth-moving machine, such as a wheel loader, excavator, dump truck, backhoe, motor grader, material handler or the like. The term “machine” can also refer to stationary equipment like a generator that is driven by an internal combustion engine to generate electricity. Additionally, a machine may also refer to an engine implemented in a marine environment such as an engine in a ship or the like.

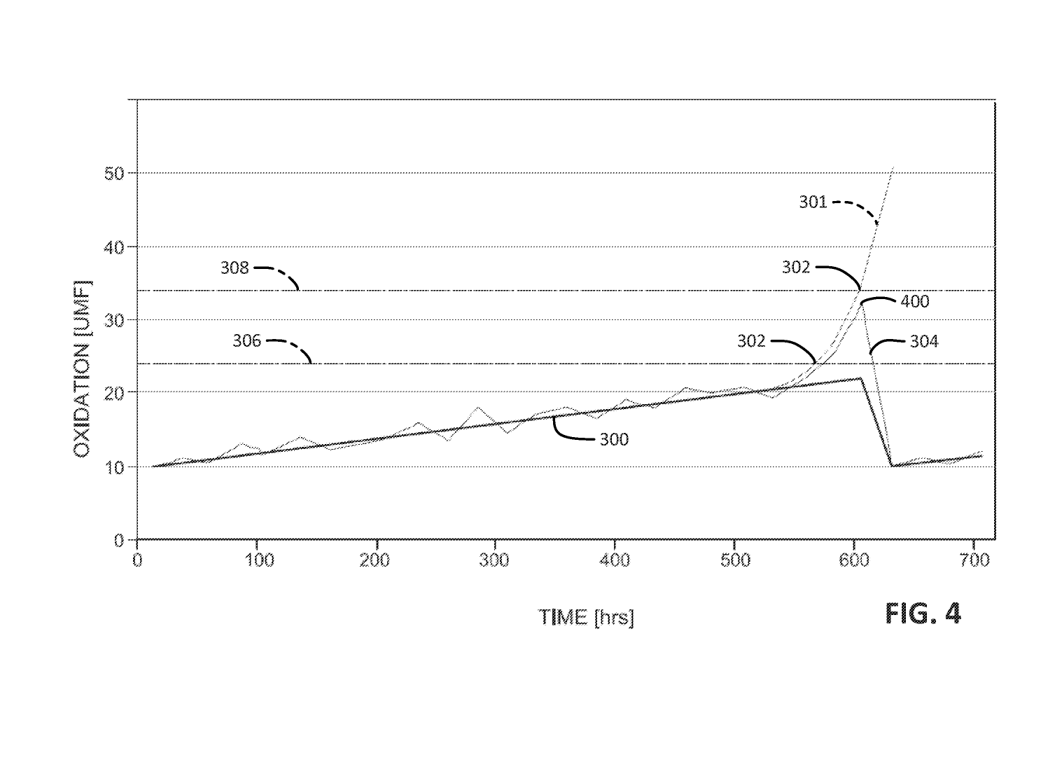

The systems and methods of the disclosure convert data from a fluid condition sensor (e.g., sensor 105) to a representation of oxidation (e.g., in Un-subtracted FTIR (Fourier transform infrared spectroscopy) Method (UFM)). As described herein, the dielectric constant of a fluid may be correlated with oxidation of the fluid. As such, data may be accessed or received at particular operating states (e.g., temperatures, time periods within fluid cycle, etc.) periodically or continuously. A trend line of fluid oxidation (e.g., degradation) may be established using a new fluid period (e.g., about 200 hours), which allow for establishing a relatively stable trend line for the current fluid change cycle. Machine data from the new fluid period may be used to predict when the oxidation hook is expected to occur, such as illustrated in FIG. 3 as curves 300, 301. As more data is received as the fluid cycle continues, the expected hook point may be shifted. Once the estimated oxidation hook is established, condemnation limits (e.g., thresholds 306, 308) may be used to develop a remaining useful life expectation. Maintenance recommendations may be made based on how the machine 101 has been operated throughout the current fluid change cycle. For example, as illustrated in FIG. 4, a fluid change may be scheduled to avoid a predicted oxidation hook and to restart the fluid cycle, at 400.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method for determining a remaining life of a fluid onboard a machine, the method comprising:
receiving, from a dielectric sensor onboard a machine, a dielectric constant of a fluid onboard the machine;
determining an estimate of a remaining useful life of the fluid based at least on the received dielectric constant of the fluid; and
transmitting an indicator representing the estimate of the remaining useful life of the fluid.

2. The method of claim 1, wherein the fluid comprises an engine oil, a transmission fluid, or a hydraulic fluid, or a combination thereof.

3. The method of claim 1, wherein the estimate of the remaining useful life of the fluid is expressed in terms of a percentage or a time period.

4. The method of claim 1, wherein determining the estimate of the remaining useful life of the fluid comprises correlating the dielectric constant with an oxidation of the fluid.

5. The method of claim 1, further comprising determining a temperature profile of the fluid, wherein the determining the estimate of the remaining useful life of the fluid is based at least on the determined temperature profile.

6. The method of claim 1, wherein the indicator is transmitted to an interface onboard the machine.

7. The method of claim 1, wherein the indicator is transmitted to an interface external to the machine.

8. A system for determining a remaining life of a fluid onboard a machine, the system comprising:
a sensor configured to determine a dielectric constant of a fluid; and
a controller configured to receive or access the determined dielectric constant of the fluid and to determine an estimate of a remaining useful life of the fluid based at least on the determined dielectric constant of the fluid.

9. The system of claim 8, wherein the fluid comprises an engine oil, a transmission fluid, or a hydraulic fluid, or a combination thereof.

10. The system of claim 8, wherein the estimate of the remaining useful life of the fluid is expressed in terms of a percentage or a time period.

11. The system of claim 8, wherein determining the estimate of the remaining useful life of the fluid comprises correlating the dielectric constant with an oxidation of the fluid.

12. The system of claim 8, further comprising determining a temperature profile of the fluid, wherein the determining the estimate of the remaining useful life of the fluid is based at least on the determined temperature profile.

13. The system of claim 8, wherein an indicator is transmitted to an interface onboard the machine.

14. The system of claim 8, wherein an indicator is transmitted to an interface external to the machine.

15. A method for determining a remaining life of a fluid onboard a machine, the method comprising:
receiving, from a dielectric sensor onboard a machine, a dielectric constant of a fluid onboard the machine;
determining a condition curve for the fluid based at least one the dielectric constant;
determining an estimate of a remaining useful life of the fluid based at least on the condition curve; and
transmitting an indicator representing the estimate of the remaining useful life of the fluid.

16. The method of claim 15, wherein the fluid comprises an engine oil, a transmission fluid, or a hydraulic fluid, or a combination thereof.

17. The method of claim 15, wherein the estimate of the remaining useful life of the fluid is expressed in terms of a percentage or a time period.

18. The method of claim 15, wherein determining the estimate of the remaining useful life of the fluid comprises correlating the dielectric constant with an oxidation of the fluid.

19. The method of claim 15, further comprising determining a temperature profile of the fluid, wherein the determining the estimate of the remaining useful life of the fluid is based at least on the determined temperature profile.

20. The method of claim 15, wherein the indicator is transmitted to an interface onboard the machine.
